(19) United States
(12) Patent Application Publication
(10) Pub. No.: US 2017/0203621 A1
(43) Pub. Date: Jul. 20, 2017

(54) TIRE HAVING SCREW-TYPE NOZZLE

(71) Applicant: INNOVA RUBBER CO., LTD., CHANGHUA (TW)

(72) Inventor: Hsi-Ming HSIEH, CHANGHUA (TW)

(21) Appl. No.: 15/409,956

(22) Filed: Jan. 19, 2017

(30) Foreign Application Priority Data
Jan. 19, 2016 (TW) 105200741

(51) Int. Cl. B60C 29/04; B60C 5/16

(52) U.S. Cl. CPC B60C 29/04; B60C 5/16

(57) ABSTRACT

A tire includes a tire body, a sealing film fastened to two side edge portions of the tire body and defining a gas chamber with the tire body, and a nozzle including an inserting member and an exterior screw member. The inserting member has an inner stopping portion disposed on an inner surface of the sealing film, a screw rod extended from the inner stopping portion and through the sealing film, and a gas-charging channel passing through the inner stopping portion and the screw rod and communicating with the gas chamber. The exterior screw member is screwed onto the screw rod and directly or indirectly urged against an outer surface of the sealing film.

### BACKGROUND OF THE INVENTION

1. Field of the Invention

The present invention relates generally to all tires for bicycles, motorcycles, beach buggies and so on, and more particularly to a tire having a screw-type nozzle.

2. Description of the Related Art

Taiwan Patent No. M252573 disclosed a tire having no inner tube, which includes an open tire body, a sealing rubber film glued at the periphery wall of the open groove of the tire body, and a nozzle inserted through the sealing film. Compared with the traditional tire having an inner tube and an outer tire body, the aforesaid tire having no inner tube is not only lower in manufacturing cost, but also more convenient and safer in usage. However, the aforesaid tire is unacceptable in the market because of having the following drawbacks.

First, the nozzle is fastened to the sealing film by glue. However, the sealing film and the nozzle are made of different materials, so they are difficult to be firmly fastened to each other by glue. Therefore, the nozzle is liable to come off to make the tire leak air quickly, causing danger and inconvenience in usage. Besides, the sealing film is heavier than the traditional inner tube. Therefore, the aforesaid tire is heavier than the traditional tire having the inner tube and the outer tire body, and the performance of the aforesaid tire is thereby affected. Furthermore, the sealing film has high ductility and low structural strength. After the tire is used under low pressure for a long time, the sealing film is liable to have rips located adjacent to the periphery of the nozzle, causing danger in usage.

### SUMMARY OF THE INVENTION

The present invention has been accomplished in view of the above-noted circumstances. It is an objective of the present invention to provide a tire which not only has the aforesaid advantages of the tire having no inner tube, but also has a screw-type nozzle less possibly coming off, thereby safer and more convenient in usage.

To attain the above objective, the present invention provides a tire which includes a tire body, a sealing film and a nozzle. The tire body has an open groove and two side edge portions adjacent to the open groove. The sealing film is fastened to the two side edge portions of the tire body by heat curing, and defines a gas chamber with the tire body. The sealing film has an inner surface facing the gas chamber, an outer surface opposite to the inner surface, and an opening passing through the inner surface and the outer surface and communicating with the gas chamber. The nozzle includes an inserting member and an exterior screw member. The inserting member has an inner stopping portion disposed on the inner surface of the sealing film, a screw rod extended from the inner stopping portion and inserted through the opening of the sealing film, and a gas-charging channel passing through the inner stopping portion and the screw rod and communicating with the gas chamber. The exterior screw member is screwed onto the screw rod and directly or indirectly urged against the outer surface of the sealing film.

As a result, the nozzle is fixed to the sealing film by a screwing manner, so the nozzle is less possible to come off, ensuring convenience and safety in usage. Besides, the nozzle can be further glued to the sealing film. In other words, the nozzle can be fixed to the sealing film more firmly by both a gluing manner and a screwing manner.

In an embodiment of the present invention, the screw rod is inserted through the exterior screw member for being connected with a gas-charging device. The exterior screw member may be a screw nut. Alternately, the exterior screw member may include a plurality of screw nuts to avoid being loosed by vibration.

The nozzle may further include a washer sleeved onto the screw rod and located on the outer surface of the sealing film. The exterior screw member is abutted on the washer so as to be indirectly urged against the outer surface of the sealing film In this way, the nozzle can be fixed to the sealing film more firmly. Especially in the case that the washer is a spring washer, a better effect can be achieved.

The screw rod is inserted through an inside and an outside of a wheel rim. The nozzle may further include a cushion. The washer and the exterior screw member are located between the sealing film and the cushion. The cushion is disposed on the inside of the wheel rim for separating the washer and the exterior screw member from the inside of the wheel rim. In this way, the cushion can prevent the friction contact between the wheel rim and the washer or the exterior screw member so as to prevent the wheel rim from being damaged by the friction contact.

The nozzle may further include a threaded fastener which is screwed onto the screw rod and abutted on the outside of the wheel rim. In this way, the nozzle can be fixed to the wheel rim firmly.

In another embodiment of the present invention, an end of the screw rod is located in the exterior screw member, and the exterior screw member has a gas-inletting channel communicating with the gas-charging channel of the inserting member. The exterior screw member is adapted for being connected with a gas-charging device. Similarly, a washer may be disposed between the exterior screw member and the sealing film as described above, so that the nozzle can be fixed to the sealing film more firmly. The exterior screw member is inserted through an inside and an outside of a wheel rim. The nozzle may further include the aforesaid cushion for preventing the wheel rim from damage. The nozzle may further include a threaded fastener which is screwed onto the exterior screw member and abutted on the outside of the wheel rim so that the nozzle can be fixed to the wheel rim firmly.

The sealing film in the present invention may include only a single layer having high gas-tightness, such as a rubber layer. Alternately, the sealing film may include two outer layers made of rubber or plastic and a fabric layer located between the two outer layers. The inner surface and the outer surface of the sealing film are located at the two outer layers respectively. Alternately, the sealing film may include a fabric layer and an outer layer piled on the fabric layer. The inner surface of the sealing film is located at the fabric layer, and the outer surface of the sealing film is located at the outer layer. Alternately, the sealing film may include a fabric layer and an outer layer piled on the fabric layer. The inner surface of the sealing film is located at the outer layer, and the outer surface of the sealing film is located at the fabric layer. As a result, on the condition that the sealing film having the fabric layer is equal in thickness to or thinner than the sealing film made of only rubber or plastic, the sealing film having the fabric layer is lighter and harder to be ripped than the sealing film made of only rubber or plastic, capable of improving the usability and the safety of the tire.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention, and wherein:

FIG. 1 is a schematic sectional view of a tire having a screw-type nozzle according to a first preferred embodiment of the present invention, showing the status that the tire is not in use;

FIG. 2 is similar to FIG. 1, but showing the status that the tire is installed on a wheel rim;

FIG. 3 is a schematic sectional view of a part of a tire having a screw-type nozzle according to a second preferred embodiment of the present invention, showing a sealing film and the nozzle of the tire;

FIG. 4 is a schematic sectional view of a part of a tire having a screw-type nozzle according to a third preferred embodiment of the present invention, showing a sealing film and the nozzle of the tire; and

FIG. 5 is a schematic sectional view of a part of a tire having a screw-type nozzle according to a fourth preferred embodiment of the present invention and a wheel rim on which the tire is installed.

### DETAILED DESCRIPTION OF THE INVENTION

First of all, it is to be mentioned that same reference numerals used in the following preferred embodiments and the appendix drawings designate same or similar elements throughout the specification for the purpose of concise illustration of the present invention.

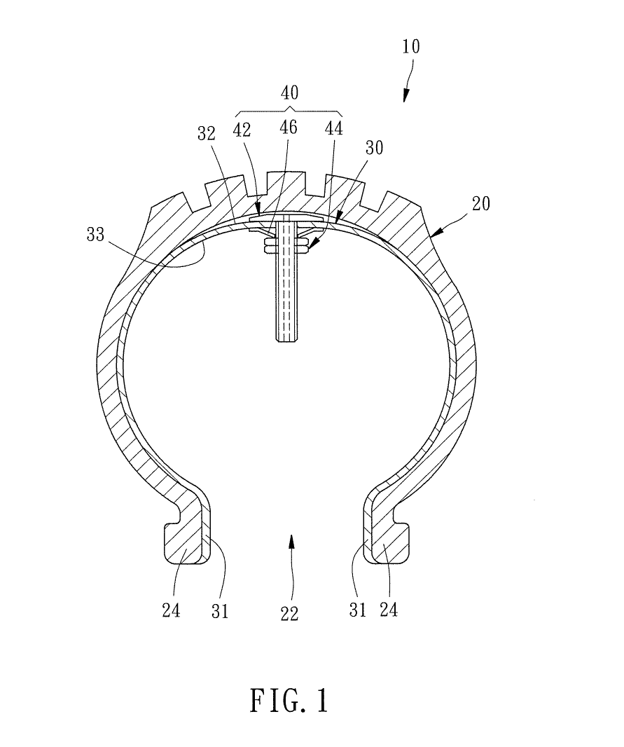

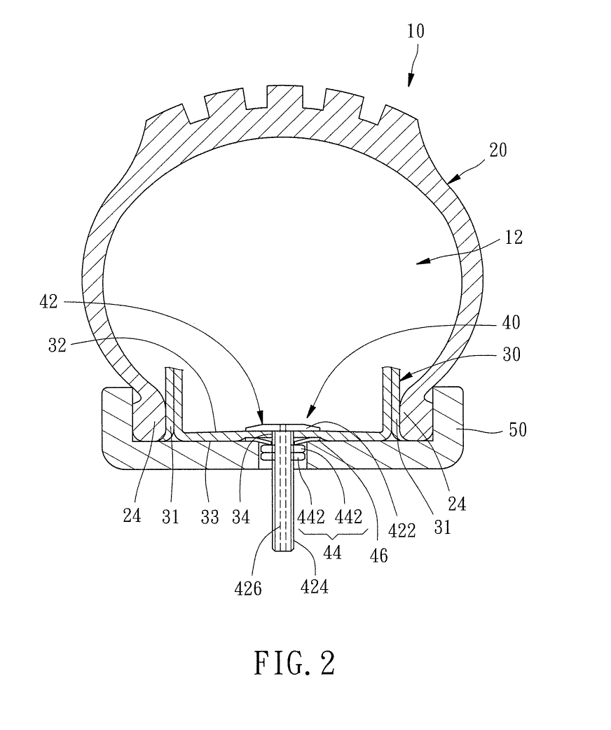

FIG. 1 is a schematic sectional view of a tire 10 having a screw-type nozzle according to a first preferred embodiment of the present invention, showing the status that the tire 10 is not in use. The tire 10 includes a tire body 20, a sealing film 30, and a nozzle 40. FIG. 2 is a schematic sectional view showing the status that the tire 10 is installed on a wheel rim 50. In general, the tire 10 can be defined with an imaginary equatorial line (not shown) which is shaped as a circle encircling the center of the tire 10. The tire body 20, the sealing film 30 and the wheel rim 50 are all extended along the imaginary equatorial line so as to be ring-shaped. The section shown in FIGS. 1-2 is perpendicular to the imaginary equatorial line. The structural feature of the present invention lies in the manner, by which the nozzle 40 is fixed to the sealing film 30. Therefore, FIGS. 1-2 are not drawn according to the actual scale, but drawn in a way that the nozzle 40 is relatively larger, for showing the structural feature clearly.

The material and the structure of the tire body 20 are similar to that commonly used by the conventional tire body, thereby not specified herein. The tire body 20 is approximately shaped as an incomplete ring in the sectional view as shown in FIGS. 1-2, therefore the tire body 20 has an open groove 22 and two side edge portions 24 adjacent to the open groove 22, which are extended along the aforesaid imaginary equatorial line so as to be ring-shaped.

The sealing film 30 in this embodiment is a flexible thin film made of material having high gas-tightness, such as rubber. That means the sealing film 30 may include only a single layer, such as a rubber. The sealing film 30 is fixedly glued to the two side edge portions 24 of the tire body 20 while being vulcanized together with the tire body 20. That means only two side edge portions 31 of the sealing film 30 are fixedly glued to the side edge portions 24 of the tire body 20 respectively, the rest of the sealing film 30 is not fastened to the tire body 20. Therefore, in the usage status as shown in FIG. 2, the sealing film 30 can be completely pulled to the open groove 22 by the user, so that the open groove 22 is closed by the sealing film 30. The sealing film 30 and the tire body 20 define a gas chamber 12 together. The sealing film 30 has an inner surface 32 facing the gas chamber 12, an outer surface 33 opposite to the inner surface 32, and an opening 34 passing through the inner surface 32 and the outer surface 33 and communicating with the gas chamber 12. The opening 34 may be formed from a cross cut provided on the sealing film 30.

The nozzle 40 includes an inserting member 42, an exterior screw member 44, and a washer 46. The inserting member 42 is shaped as a screw bolt, which has an inner stopping portion 422 and a screw rod 424 extended from the inner stopping portion 422 integrally. However, the inserting member 42 further includes a gas-charging channel 426 passing through the inner stopping portion 422 and the screw rod 424. By means of the flexibility of the sealing film 30, the inner stopping portion 422 of the inserting member 42 is squeezed through the opening 34 to be disposed on the inner surface 32 of the sealing film 30. The screw rod 424 is therefore extended through the opening 34 and protruded from the outer surface 33 of the sealing film 30. The exterior screw member 44 and the washer 46 are sleeved onto the screw rod 424, and the washer 46 is located between the outer surface 33 of the sealing film 30 and the exterior screw member 44. The exterior screw member 44 in this embodiment includes two screw nuts 442 fixedly screwed onto the screw rod 424 and abutted on the washer 46 so as to be indirectly urged against the outer surface 33 of the sealing film 30.

In other words, in the present invention the exterior screw member 44 is screwed onto the screw rod 424 tightly to clamp the sealing film 30 tightly between the inner stopping portion 422 and the washer 46, so that the nozzle 40 is fixed to the sealing film 30 and the gas-charging channel 426 communicates with the gas chamber 12. The nozzle 40 can be fixed to the sealing film 30 firmly by such manner, so as to be less possible to come off, ensuring the convenience and safety in usage. Besides, the nozzle 40 can be further glued to the sealing film 30. That means the nozzle 40 can be fixed to the sealing film 30 more firmly by both a gluing manner and a screwing manner.

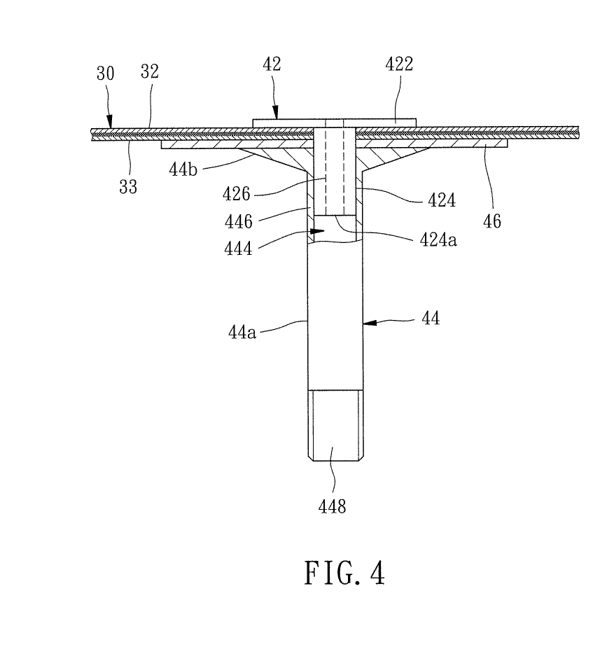

It is to be appreciated that the nozzle 40 may include no such washer 46, so that the exterior screw member 44 is directly urged against, i.e. directly abutted on the outer surface 33 of the sealing film 30. However, the nozzle 40 including the washer 46 disposed between the exterior screw member 44 and the sealing film 30 can be fixed to the sealing film 30 more firmly. Especially in the case that the washer 46 is a spring washer, such as that provided in this embodiment, a better fastening effect can be achieved. However, the washer 46 is not limited to be the spring washer, but may be a normal flat washer 46 as shown in FIG. 4 for example. Besides, the exterior screw member 44 may include only one screw nut 442. However, the nozzle 40 including a plurality of screw nuts 442 screwed onto the screw rod 424, such as that provided in this embodiment, can avoid the problem that a single screw nut may be loosed due to vibration.

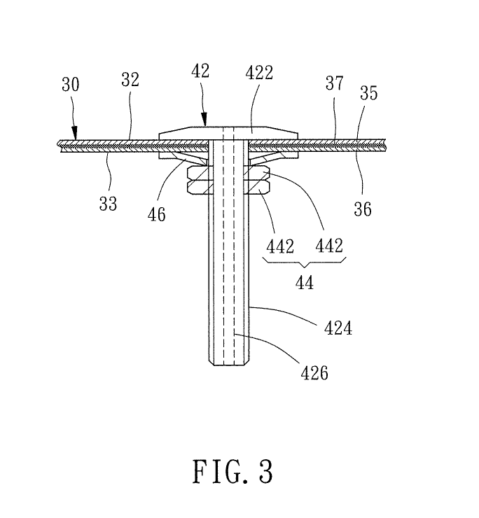

FIG. 3 is a schematic sectional view of a part of a tire having a screw-type nozzle according to a second preferred embodiment of the present invention, only showing the nozzle 40 and the partial sealing film 30 located around the nozzle 40 enlargingly, for the convenience of illustrating the structural feature of this embodiment. This embodiment is different from the aforesaid first preferred embodiment in that the sealing film 30 in this embodiment includes two outer layers 35, 36 made of rubber or plastic, and a fabric layer 37 located between the two outer layers 35, 36. The inner surface 32 and the outer surface 33 of the sealing film 30 are formed by the two outer layers 35, 36 respectively. The fabric layer 37 can be any woven cloth made of synthetic fibers or blended fabric. The two outer layers 35, 36 can be formed in a way that the top and bottom surfaces of the fabric layer 37 are covered by material having high gas-tightness (ex. rubber) and then the rubber material is heat treated to become the two outer layers 35, 36 (ex. rubber layers), so that the sealing film 30 can be glued to the tire body 20 and has high gas-tightness. On the condition that the sealing film 30 having the fabric layer 37 is equal in thickness to or thinner than the sealing film 30 made of only rubber or plastic, the sealing film 30 having the fabric layer 37 is lighter and harder to be ripped than the sealing film 30 made of only rubber or plastic, capable of improving the usability and the safety of the tire 10.

However, the sealing film 30 having the aforesaid advantage is not limited to have two outer layers 35, 36, but may have only one outer layer piled on the fabric layer 37. For example, the sealing film 30 may have no such outer layer 35; the inner surface of the sealing film is formed by the fabric layer 37, and the outer surface of the sealing film is formed by the outer layer 36. Alternately, the sealing film 30 may have no such outer layer 36; the inner surface of the sealing film is formed by the outer layer 35, and the outer surface of the sealing film is formed by the fabric layer 37.

In the aforesaid two embodiments, the screw rod 424 of the inserting member 42 is inserted through the exterior screw member 44 for being connected with a gas-charging device (not shown), so that the gas chamber 12 can be gas-charged by the gas-charging device through the gas-charging channel 426. However, the nozzle 40 in the present invention is not limited to such design, but may be that provided in a following third preferred embodiment of the present invention for example.

Referring to FIG. 4, in the third preferred embodiment of the present invention, the screw rod 424 of the inserting member 42 is relatively shorter, and the exterior screw member 44 is shaped as a long pipe, provided therein with a gas-inletting channel 444, and has an inside threaded segment 446 and an outside threaded segment 448. The internal thread of the segment 446 is not shown in FIG. 4 for simplifying the figure. The inside threaded segment 446 is screwed onto the screw rod 424 in a way that the exterior screw member 44 is directly or indirectly urged against the sealing film 30. The inside threaded segment 446 may have a length just adapted for being screwed onto the screw rod 424, or may be even longer. The inner wall of the gas-inletting channel 444 may be completely threaded. As a result, an end 424a of the screw rod 424 is located in the exterior screw member 44, and the gas-inletting channel 444 of the exterior screw member 44 communicates with the gas-charging channel 426 of the inserting member 42. The outside threaded segment 448 of the exterior screw member 44 is adapted for being connected with a gas-charging device (not shown), so that the gas chamber 12 can be gas-charged by the gas-charging device through the gas-inletting channel 444 and the gas-charging channel 426. The type of the washer 46 in this embodiment is not limited. For example, this embodiment may use the spring washer 46 as shown in FIGS. 1-3. Alternately, the nozzle 40 in this embodiment may have no washer 46.

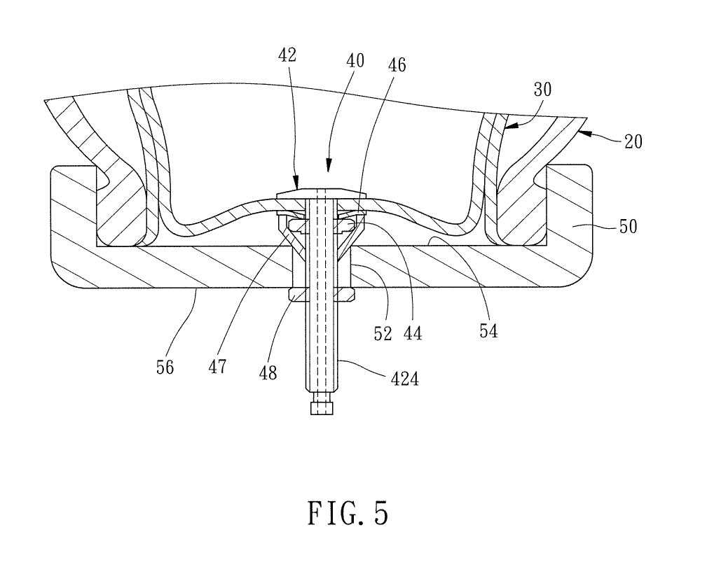

Referring to FIG. 5, the fourth preferred embodiment of the present invention is similar to the first preferred embodiment as shown in FIG. 2. However, in the embodiment as shown in FIG. 5, the nozzle 40 further includes a cushion 47 and a threaded fastener 48, and the exterior screw member 44 includes only one screw nut which is larger than the through hole 52 of the wheel rim 50, thereby not disposed in the through hole 52.

The cushion 47 is made of rubber or the like, approximately cone-shaped and sleeved onto the screw rod 424. The washer 46 and the exterior screw member 44 are located between the sealing film 30 and the cushion 47. The cushion 47 is capped on the washer 46 and the exterior screw member 44, disposed on the inside 54 of the wheel rim 50 and partially located in the through hole 52 for separating the washer 46 and the exterior screw member 44 from the inside 54 of the wheel rim 50. Since the washer 46 and the exterior screw member 44 are usually made of metal, the wheel rim 50, if it is made of nonmetal such as carbon fibers, is liable to be damaged by the friction contact between the wheel rim 50 and the washer 46 or the exterior screw member 44, especially at the periphery of the through hole 52. Such damage of the wheel rim 50, which may cause the nozzle 40 to sway, can be avoided by the cushion 47 disposed on the inside 54 of the wheel rim 50.

The threaded fastener 48 is a screw nut, which is screwed onto the screw rod 424 for fastening the nozzle 40 to the wheel rim 50. When the threaded fastener 48 is tightened, it is abutted on the outside 56 of the wheel rim 50, and the nozzle 40 is fixed to the wheel rim 50 firmly. For simplifying the figure, the cushion 47 in FIG. 5 is not deformed and shaped originally. In fact, when the threaded fastener 48 is tightened, the cushion 47 is compressed and deformed, causing the nozzle 40 to a little move toward the outside 56 of the wheel rim 50.

The aforesaid cushion 47 is also applicable in the case as shown in FIG. 4. In such case, the body portion 44a of the exterior screw member 44 is inserted through the through hole 52 of the wheel rim 50, and the cushion 47 is sleeved onto the body portion 44a of the exterior screw member 44 to separate the head portion 44b of the exterior screw member 44 from the inside 54 of the wheel rim 50. The aforesaid threaded fastener 48 is also applicable in the case as shown in FIG. 4. In such case, the threaded fastener 48 is screwed onto the body portion 44a of the exterior screw member 44 and abutted on the outside 56 of the wheel rim 50, thereby fastening the nozzle 40 to the wheel rim 50.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A tire comprising:
a tire body having an open groove and two side edge portions adjacent to the open groove;
a sealing film fastened to the two side edge portions of the tire body, defining a gas chamber with the tire body, and having an inner surface facing the gas chamber, an outer surface opposite to the inner surface, and an opening passing through the inner surface and the outer surface and communicating with the gas chamber; and
a nozzle comprising an inserting member and an exterior screw member, the inserting member having an inner stopping portion disposed on the inner surface of the sealing film, a screw rod extended from the inner stopping portion and inserted through the opening of the sealing film, and a gas-charging channel passing through the inner stopping portion and the screw rod and communicating with the gas chamber, the exterior screw member being screwed onto the screw rod and directly or indirectly urged against the outer surface of the sealing film.

2. The tire as claimed in claim 1, wherein the nozzle further comprises a washer sleeved onto the screw rod and located on the outer surface of the sealing film; the exterior screw member is abutted on the washer so as to be indirectly urged against the outer surface of the sealing film.

3. The tire as claimed in claim 2, wherein the washer is a spring washer.

4. The tire as claimed in claim 3, wherein the screw rod is inserted through the exterior screw member for being connected with a gas-charging device.

5. The tire as claimed in claim 4, wherein the screw rod is inserted through an inside and an outside of a wheel rim; the nozzle further comprises a cushion; the washer and the exterior screw member are located between the sealing film and the cushion; the cushion is disposed on the inside of the wheel rim for separating the washer and the exterior screw member from the inside of the wheel rim.

6. The tire as claimed in claim 5, wherein the nozzle further comprises a threaded fastener which is screwed onto the screw rod and abutted on the outside of the wheel rim.

7. The tire as claimed in claim 4, wherein the exterior screw member is a screw nut.

8. The tire as claimed in claim 4, wherein the exterior screw member comprises a plurality of screw nuts.

9. The tire as claimed in claim 3, wherein an end of the screw rod is located in the exterior screw member; the exterior screw member has a gas-inletting channel communicating with the gas-charging channel of the inserting member; the exterior screw member is adapted for being connected with a gas-charging device.

10. The tire as claimed in claim 2, wherein an end of the screw rod is located in the exterior screw member; the exterior screw member has a gas-inletting channel communicating with the gas-charging channel of the inserting member; the exterior screw member is adapted for being connected with a gas-charging device.

11. The tire as claimed in claim 2, wherein the screw rod is inserted through the exterior screw member for being connected with a gas-charging device.

12. The tire as claimed in claim 1, wherein the nozzle is glued to the sealing film.

13. The tire as claimed in claim 1, wherein the sealing film comprises a rubber layer.

14. The tire as claimed in claim 1, wherein the sealing film comprises two outer layers made of rubber or plastic and a fabric layer located between the two outer layers; the inner surface and the outer surface of the sealing film are located at the two outer layers respectively.

15. The tire as claimed in claim 1, wherein the sealing film comprises a fabric layer and an outer layer made of rubber or plastic piled on the fabric layer; the inner surface of the sealing film is located at one of the fabric layer and the outer layer, and the outer surface of the sealing film is located at the other of the fabric lay and the outer layer.

16. The tire as claimed in claim 1, wherein an end of the screw rod is located in the exterior screw member; the exterior screw member has a gas-inletting channel communicating with the gas-charging channel of the inserting member; the exterior screw member is adapted for being connected with a gas-charging device.

17. The tire as claimed in claim 1, wherein the screw rod is inserted through the exterior screw member for being connected with a gas-charging device.

18. The tire as claimed in claim 1, wherein the nozzle further comprises a washer sleeved onto the screw rod and located on the outer surface of the sealing film in a way that the exterior screw member is abutted on the washer so as to be indirectly urged against the outer surface of the sealing film, and a cushion; the washer and the exterior screw member are located between the sealing film and the cushion.

19. The tire as claimed in claim 18, wherein the nozzle is inserted through an inside and an outside of a wheel rim; the cushion is disposed on the inside of the wheel rim for separating the exterior screw member from the inside of the wheel rim.

20. The tire as claimed in claim 19, wherein the nozzle further comprises a threaded fastener screwed onto the screw rod and abutted on the outside of the wheel rim.
